(19) United States
(12) Patent Application Publication
(10) Pub. No.: US 2025/0061311 A1
(43) Pub. Date: Feb. 20, 2025

(54) DATA GENERATION

(71) Applicant: BEIJING BAIDU NETCOM SCIENCE TECHNOLOGY CO., LTD., BEIJING (CN)

(72) Inventors: Zeyang LEI, BEIJING (CN); Siqi BAO, BEIJING (CN); Hua WU, BEIJING (CN); Haifeng WANG, BEIJING (CN)

(73) Assignee: BEIJING BAIDU NETCOM SCIENCE TECHNOLOGY CO., LTD., BEIJING (CN)

(21) Appl. No.: 18/746,532

(22) Filed: Jun. 18, 2024

(30) Foreign Application Priority Data
Jun. 30, 2023 (CN) 202310798540.8

(51) Int. Cl. G06N 3/0475; G06N 3/08

(52) U.S. Cl. CPC G06N 3/0475; G06N 3/08

(57) ABSTRACT

A data generation method is provided. The data generation method includes: generating first answer data based on first question data from a user; determining, in response to receiving negative feedback from the user for the first answer data, a first reflection result for the first answer data based on the first answer data and the negative feedback, wherein the first reflection result indicates a diagnosis reason why feedback from the user for the first answer data is negative; and generating second answer data for the first question data based on the first question data and the first reflection result.

### CROSS REFERENCE TO RELATED APPLICATION

This application claims priority to Chinese Patent Application No. 202310798540.8, filed on Jun. 30, 2023, the contents of which are hereby incorporated by reference in their entirety for all purposes.

### TECHNICAL FIELD

The present disclosure relates to the technical field of artificial intelligence, in particular, to the fields of natural language processing, deep learning, etc., and specifically, to a data generation method and apparatus, an electronic device, a computer-readable storage medium, and a computer program product.

### BACKGROUND

Artificial intelligence is a subject on making a computer simulate some thinking processes and intelligent behaviors (such as learning, reasoning, thinking, and planning) of a human, and involves both hardware-level technologies and software-level technologies. Artificial intelligence hardware technologies generally include technologies such as sensors, dedicated artificial intelligence chips, cloud computing, distributed storage, and big data processing. Artificial intelligence software technologies mainly include the following several general directions: computer vision technologies, speech recognition technologies, natural language processing technologies, machine learning/deep learning, big data processing technologies, and knowledge graph technologies.

Large generative language models are applicable to various natural language processing tasks, and are in particular capable of generating natural language text for reply based on question content of users to achieve interaction with the users.

Methods described in this section are not necessarily methods that have been previously conceived of or employed. It should not be assumed that any of the methods described in this section is considered to be the prior art just because they are included in this section, unless otherwise indicated expressly. Similarly, the problem mentioned in this section should not be considered to be universally recognized in any prior art, unless otherwise indicated expressly.

### SUMMARY

The present disclosure provides a data generation method and apparatus, an electronic device, a computer-readable storage medium, and a computer program product.

According to an aspect of the present disclosure, there is provided a data generation method, including: generating first answer data based on first question data from a user; determining, in response to receiving negative feedback from the user for the first answer data, a first reflection result for the first answer data based on the first answer data and the negative feedback, wherein the first reflection result indicates a diagnosis reason why feedback from the user for the first answer data is negative; and generating second answer data for the first question data based on the first question data and the first reflection result.

According to another aspect of the present disclosure, there is provided an electronic device, including: at least one processor; and a memory communicatively connected to the at least one processor, where the memory stores instructions executable by the at least one processor, and the instructions, when executed by the at least one processor, cause the at least one processor to perform operations comprising: generating first answer data based on first question data from a user; determining, in response to receiving negative feedback from the user for the first answer data, a first reflection result for the first answer data based on the first answer data and the negative feedback, wherein the first reflection result indicates a diagnosis reason why feedback from the user for the first answer data is negative; and generating second answer data for the first question data based on the first question data and the first reflection result.

According to another aspect of the present disclosure, there is provided a non-transitory computer-readable storage medium storing computer instructions, where the computer instructions are used to cause the computer to perform operations comprising: generating first answer data based on first question data from a user; determining, in response to receiving negative feedback from the user for the first answer data, a first reflection result for the first answer data based on the first answer data and the negative feedback, wherein the first reflection result indicates a diagnosis reason why feedback from the user for the first answer data is negative; and generating second answer data for the first question data based on the first question data and the first reflection result.

According to one or more embodiments of the present disclosure, the quality of answer data generated may be improved.

It should be understood that the content described in this section is not intended to identify critical or important features of the embodiments of the present disclosure, and is not used to limit the scope of the present disclosure. Other features of the present disclosure will be readily understood with reference to the following description.

### BRIEF DESCRIPTION OF THE DRAWINGS

The accompanying drawings show example embodiments and form a part of the specification, and are used to explain example implementations of the embodiments together with a written description of the specification. The embodiments shown are merely for illustrative purposes and do not limit the scope of the claims. Throughout the accompanying drawings, the same reference numerals denote similar but not necessarily same elements.

FIG. 1 is a schematic diagram of an example system in which various methods described herein may be implemented according to an example embodiment of the present disclosure;

FIG. 2 is a flowchart of a data generation method according to an example embodiment of the present disclosure;

FIG. 3 is a schematic diagram of a data generation process according to an example embodiment of the present disclosure;

FIG. 4 is a block diagram of a structure of a data generation apparatus according to an example embodiment of the present disclosure; and

FIG. 5 is a block diagram of a structure of an example electronic device that can be used to implement an embodiment of the present disclosure.

### DETAILED DESCRIPTION OF EMBODIMENTS

Example embodiments of the present disclosure are described below in conjunction with the accompanying drawings, where various details of the embodiments of the present disclosure are included to facilitate understanding, and should only be considered as example. Therefore, those of ordinary skill in the art should be aware that various changes and modifications can be made to the embodiments described here, without departing from the scope of the present disclosure. Likewise, for clarity and conciseness, the description of well-known functions and structures is omitted in the following description.

In the present disclosure, unless otherwise stated, the terms “first”, “second”, etc., used to describe various elements are not intended to limit the positional, temporal or importance relationship of these elements, but rather only to distinguish one component from another. In some examples, a first element and a second element may refer to a same instance of the element, and in some cases, based on contextual descriptions, the first element and the second element may also refer to different instances.

The terms used in the description of the various examples in the present disclosure are merely for the purpose of describing particular examples, and are not intended to be limiting. If the number of elements is not specifically defined, there may be one or more elements, unless otherwise expressly indicated in the context. Moreover, the term “and/or” used in the present disclosure encompasses any of and all possible combinations of listed terms.

In the related art, when a generative language model is applied to generate answer data based on input data of a user, the performance of the model is usually enhanced by a manually annotated corpus or by adjusting a training method (such as optimizing a loss function or performing reinforcement learning) during a training phase of the model. During an application phase of the model, that is, during a data generation process, answer data is usually directly generated based on question data input by the user, and the corresponding answer data cannot be adjusted according to feedback of the user for the answer data. As a result, the quality of the answer data cannot fully meet the needs of the user.

On this basis, the present disclosure provides a data generation method. In the method, after initial answer data is generated for question data of a user, when negative feedback for the answer data is received from the user, a reason why the answer data receives the negative feedback is self-diagnosed based on the negative feedback, and then a reflection result for the answer data is generated, so as to generate new answer data based on the reflection result, thereby enabling the answer data to be more in line with the needs of the user and improving the quality of answer data generated.

The embodiments of the present disclosure will be described below in detail with reference to the accompanying drawings.

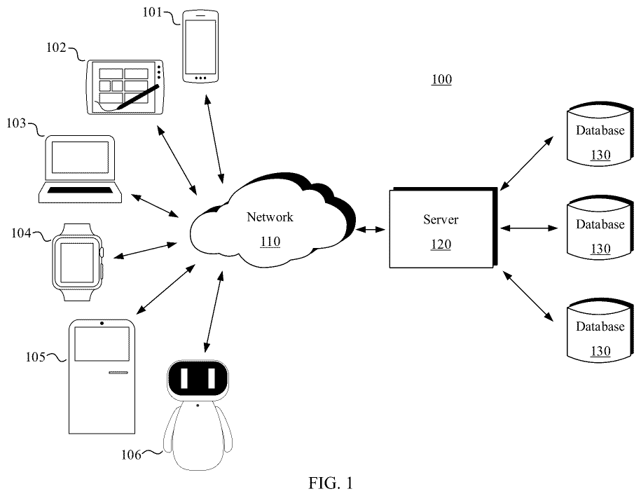

FIG. 1 is a schematic diagram of an example system 100 in which various methods and apparatuses described herein may be implemented according to an embodiment of the present disclosure. Referring to FIG. 1, the system 100 includes one or more client devices 101, 102, 103, 104, 105, and 106, a server 120, and one or more communications networks 110 that couple the one or more client devices to the server 120. The client devices 101, 102, 103, 104, 105, and 106 may be configured to execute one or more applications.

In an embodiment of the present disclosure, the server 120 may run one or more services or software applications that enable a data generation method to be performed.

In some embodiments, the server 120 may further provide other services or software applications that may include a non-virtual environment and a virtual environment. In some embodiments, these services may be provided as web-based services or cloud services, for example, provided to a user of the client devices 101, 102, 103, 104, 105, and/or 106 in a software as a service (SaaS) model.

In the configuration shown in FIG. 1, the server 120 may include one or more components that implement functions performed by the server 120. These components may include software components, hardware components, or a combination thereof that can be executed by one or more processors. A user operating the client devices 101, 102, 103, 104, 105, and/or 106 may sequentially use one or more client application programs to interact with the server 120, to use the services provided by these components. It should be understood that various different system configurations are possible, and may be different from that of the system 100. Therefore, FIG. 1 is an example of the system for implementing various methods described herein, and is not intended to be limiting.

The user may use the client devices 101, 102, 103, 104, 105, and/or 106 to send question data and feedback. The client device may provide an interface that enables the user of the client device to interact with the client device. The client device may also output information to the user via the interface. Although FIG. 1 shows only six client devices, those skilled in the art will understand that any number of client devices are supported in the present disclosure.

The client devices 101, 102, 103, 104, 105, and/or 106 may include various types of computer devices, for example, a portable handheld device, a general-purpose computer (for example, a personal computer and a laptop computer), a workstation computer, a wearable device, a smart screen device, a self-service terminal device, a service robot, a gaming system, a thin client, various messaging devices, and a sensor or other sensing devices. These computer devices may run various types and versions of software application programs and operating systems, such as MICROSOFT Windows, APPLE IOS, a UNIX-like operating system, and a Linux or Linux-like operating system (e.g., GOOGLE Chrome OS); or include various mobile operating systems, such as MICROSOFT Windows Mobile OS, iOS, Windows Phone, and Android. The portable handheld device may include a cellular phone, a smartphone, a tablet computer, a personal digital assistant (PDA), etc. The wearable device may include a head-mounted display (such as smart glasses) and other devices. The gaming system may include various handheld gaming devices, Internet-enabled gaming devices, etc. The client device can execute various applications, such as various Internet-related applications, communication applications (e.g., email applications), and short message service (SMS) applications, and can use various communication protocols.

The network 110 may be any type of network well known to those skilled in the art, and may use any one of a plurality of available protocols (including but not limited to TCP/IP, SNA, IPX, etc.) to support data communication. As a mere example, the one or more networks 110 may be a local area network (LAN), an Ethernet-based network, a token ring, a wide area network (WAN), the Internet, a virtual network, a virtual private network (VPN), an intranet, an extranet, a blockchain network, a public switched telephone network (PSTN), an infrared network, a wireless network (such as Bluetooth or Wi-Fi), and/or any combination of these and/or other networks.

The server 120 may include one or more general-purpose computers, a dedicated server computer (for example, a personal computer (PC) server, a UNIX server, or a terminal server), a blade server, a mainframe computer, a server cluster, or any other suitable arrangement and/or combination. The server 120 may include one or more virtual machines running a virtual operating system, or other computing architectures related to virtualization (e.g., one or more flexible pools of logical storage devices that can be virtualized to maintain virtual storage devices of a server). In various embodiments, the server 120 may run one or more services or software applications that provide functions described below.

A computing unit in the server 120 may run one or more operating systems including any of the above operating systems and any commercially available server operating system. The server 120 may also run any one of various additional server applications and/or middle-tier applications, including an HTTP server, an FTP server, a CGI server, a JAVA server, a database server, etc.

In some implementations, the server 120 may include one or more applications to analyze and merge data feeds and/or event updates received from users of the client devices 101, 102, 103, 104, 105, and 106. The server 120 may further include one or more applications to display the data feeds and/or real-time events via one or more display devices of the client devices 101, 102, 103, 104, 105, and 106.

In some implementations, the server 120 may be a server in a distributed system, or a server combined with a blockchain. The server 120 may alternatively be a cloud server, or an intelligent cloud computing server or intelligent cloud host with artificial intelligence technologies. The cloud server is a host product in a cloud computing service system, to overcome the shortcomings of difficult management and weak service scalability in conventional physical host and virtual private server (VPS) services.

The system 100 may further include one or more databases 130. In some embodiments, these databases may be used to store data and other information. For example, one or more of the databases 130 may be used to store information such as an audio file and a video file. The databases 130 may reside in various locations. For example, a database used by the server 120 may be locally in the server 120, or may be remote from the server 120 and may communicate with the server 120 via a network-based or dedicated connection. The database 130 may be of different types. In some embodiments, the database used by the server 120 may be, for example, a relational database. One or more of these databases may store, update, and retrieve data from or to the database, in response to a command.

In some embodiments, one or more of the databases 130 may also be used by an application to store application data. The database used by the application may be of different types, for example, may be a key-value repository, an object repository, or a regular repository backed by a file system.

The system 100 of FIG. 1 may be configured and operated in various manners, such that the various methods and apparatuses described according to the present disclosure can be applied.

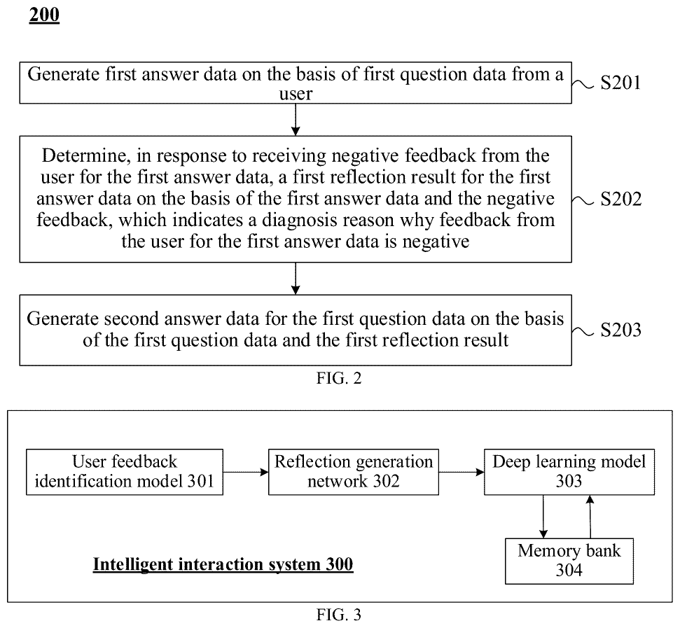

FIG. 2 is a flowchart of a data generation method 200 according to an example embodiment of the present disclosure. As shown in FIG. 2, the method 200 includes the following steps:
Step S201: Generate first answer data based on first question data from a user.
Step S202: Determine, in response to receiving negative feedback from the user for the first answer data, a first reflection result for the first answer data based on the first answer data and the negative feedback, the first reflection result indicating a diagnosis reason why feedback from the user for the first answer data is negative.
Step S203: Generate second answer data for the first question data based on the first question data and the first reflection result.

With the data generation manner described in the method 200, after the first answer data is generated for the question data input by the user, when the negative feedback for the first answer data is received from the user, the reflection result for the first answer data can be generated based on the negative feedback to achieve self-diagnosis, and then the new second answer data is generated based on the reflection result, so that the new second answer data is more in line with the needs of the user and the quality of answer data generated is improved.

In some examples, the first question data, the first answer data, the second answer data, and the first reflection result may be natural language text. For example, the first question data may be “Help me write a five-word car advertising slogan”. In this case, when the generated first answer data is an advertising slogan containing seven words and the user gives negative feedback for the first answer data, a reason for receiving the negative feedback may be self-diagnosed to obtain the first reflection result “The user requires a five-word advertising slogan, but the generated result contains seven words, and the number of words does not meet the requirement of the user”. The first reflection result is used to indicate the possible reason why the negative feedback is received for the first answer data, and the new second answer data can be generated on this basis to avoid receiving negative feedback from the user again for the second answer data, thereby improving the quality of answer data generated.

According to some embodiments, the first reflection result further includes an optimization strategy for the first answer data. Therefore, data can be generated based on the reflection result that further includes the optimization strategy, so as to obtain second answer data that is more targeted and has richer and more specific content based on the reflection result.

In the above example, the reflection result may be “The user requires a five-word advertising slogan, but the generated result contains seven words, and the number of words does not meet the requirement of the user. A result re-generated needs to include five words”. By generating the new second answer data based on the reflection result including the optimization strategy of “A result re-generated needs to include five words”, the quality of the second answer data generated can be improved, thereby improving the user experience.

According to some embodiments, the generating first answer data based on first question data from a user in step S201 includes: determining first input data for a deep learning model based on the first question data, the deep learning model being used to generate answer data based on input data; and inputting the first input data into the deep learning model to obtain the first answer data, and the generating second answer data for the first question data based on the first question data and the first reflection result in step S203 includes: determining second input data for the deep learning model based on the first question data and the first reflection result; and inputting the second input data into the deep learning model to obtain the second answer data. Therefore, the deep learning model can be used to generate answer data. By generating the first input data and the second input data indicating different needs and inputting the first input data and the second input data into the deep learning model, the same deep learning model can be used to generate the first answer data and the second answer data, thereby improving the efficiency and convenience.

In some examples, the deep learning model for generating answer data based on input data has an end-to-end characteristic, and can directly generate answer data in the form of natural language text based on input data in the form of natural language text. In some examples, the deep learning model may use an N-layer transformer network structure that has an encoder and a decoder, or a unified pre-trained language model (UniLM) network structure. It can be understood that the deep learning model may alternatively be another neural network model based on a transformer network structure, which is not limited herein.

In some examples, the deep learning model may be trained using a sample corpus, and the sample corpus used to train the deep learning model may include, for example, sample input data and sample answer data for the sample input data. During a training process, the sample input data may be input into the deep learning model to obtain predicted answer data, a loss value may be calculated based on the predicted answer data and the sample answer data, and further a parameter of the deep learning model may be adjusted based on the loss value. In some examples, the loss value of the deep learning model may be determined based on a negative-log likelihood (NLL) loss calculation method.

In some examples, different corpora may be used to train the deep learning model applied to step S201 and the deep learning model applied to step S203, respectively, so as to improve the accuracy of answer content generated by the model by using more targeted training corpora.

According to some embodiments, the determining second input data for the deep learning model based on the first question data and the first reflection result includes: determining the second input data based on the first question data, the first reflection result, and task description information, the task description information indicating that the second input data includes the first reflection result. Thus, by adding the task description information based on the input content, a current data generation need can be explicitly indicated, so that the deep learning model can generate the second input data based on the first reflection result and the first question data to improve data generation efficiency.

Referring to the example described above, in this example, the first question data, the first answer data, the second answer data, and the first reflection result are all natural language text, and the deep learning model is also used to receive and generate natural language text. In this case, the task description information may be a preset natural language text segment or template, used to indicate the existence of the first question data and the first reflection result in the input data. The task description information may be, for example: Generate answer data for the first question data based on the first question data and the first reflection result. By filling the content of the first question data and the first reflection result into the template, input data that can clearly indicate the data generation need may be obtained, so that the deep learning model can generate the second answer data on this basis.

It should be understood that the above implementation is only an example of the input data of the deep learning model, and the input data may also be generated based on other methods. For example, a label of a predefined generation mode may be directly added based on the first question data and the first reflection result to obtain the second input data, so that the deep learning model can determine, based on the label, that the second input data includes the first reflection result. The present disclosure does not limit the method of determining the input data, provided that the deep learning model is enabled to perceive the existence of a reflection result in the input data and generate answer data based on the reflection result.

According to some embodiments, the determining a first reflection result for the first answer data based on the first answer data and the first feedback in step S202 includes: inputting the first answer data and the first feedback into a reflection generation network to obtain the first reflection result output by the reflection generation network, where the reflection generation network is trained using a sample corpus, and the sample corpus includes sample answer data, sample feedback, and a sample reflection result for the sample answer data. Therefore, the trained reflection generation network can be used to obtain reflection results, thereby improving the efficiency and convenience of generating reflection results.

In some examples, the reflection generation network may use an N-layer transformer network structure that has an encoder and a decoder, or a unified pre-trained language model (UniLM) network structure. Similar to the training method of the deep learning model described above, the reflection generation network may be trained using a sample corpus. The sample corpus used to train the reflection generation network may include, for example, sample answer data, sample feedback, and a sample reflection result for the sample answer data. During a training process, the sample answer data and the sample feedback may be input into the deep learning model to obtain a predicted reflection result, a loss value may be calculated based on the predicted reflection result and the sample reflection result, and then a parameter of the reflection generation network may be adjusted based on the loss value.

According to some embodiments, the determining, in response to receiving negative feedback from the user for the first answer data, a first reflection result for the first answer data based on the first answer data and the negative feedback in step S202 includes: determining, in response to receiving first feedback from the user for the first answer data, and in response to determining that the first feedback is negative feedback, the first reflection result for the first answer data based on the first answer data and the first feedback. Thus, it is possible to further determine whether the feedback data is negative feedback after the feedback data of the user is obtained, so that the negative feedback can be further identified through a determination step when the feedback data does not explicitly indicate whether the feedback is negative feedback, so as to improve the accuracy.

In some examples, a classifier-based user feedback identification model may be used to distinguish whether the first feedback is negative feedback. In some examples, the user feedback identification model may be trained using a sample feedback data set annotated with real attribute labels (including positive feedback and negative feedback), so as to more efficiently and accurately determine whether the first feedback from the user is negative feedback.

In some examples, whether negative feedback is received from the user may be determined by other methods. In one example, the receipt of negative feedback may be determined based on an operation of the user on a user interface, for example, the receipt of negative feedback may be determined in response to determining that the user clicks on a bad review button or gives a score below a threshold.

According to some embodiments, the method 200 further includes: generating, in response to determining that a similarity between second question data from the user and the first question data exceeds a preset threshold, third answer data for the second question data based on the first question data, the second answer data, and the second question data. Thus, when the user sends the second question data similar to the first question data, the first question data and the second answer data can be used to enhance the generation of the current third answer data, so as to improve the quality of answer data generated.

In some examples, the question data may all be represented as text vectors, and the similarity between the first question data and the second question data may be determined by calculating a vector similarity.

According to some embodiments, the method 200 further includes: storing the first question data and the second answer data into a memory bank, where the generating, in response to determining that a similarity between second question data from the user and the first question data exceeds a preset threshold, third answer data for the second question data based on the first question data, the second answer data, and the second question data includes: obtaining the second answer data from the memory bank in response to determining that the similarity between the second question data from the user and the first question data in the memory bank exceeds the preset threshold; and generating the third answer data based on the first question data, the second answer data, and the second question data. Thus, the memory bank can be used to store question data-answer data pairs. A larger amount of historical conversation data over a longer period of time can be saved by using the memory bank, and then the generation of the current answer data can be enhanced by referring to the historical conversations, so as to improve the quality of answer data generated.

In some examples, when the deep learning model as described above is used to generate answer data, third input data for the deep learning model may be determined based on the first question data, the second answer data, and the second question data, and then the third input data is input into the deep learning model to obtain the third answer data. In an example, the third answer data may include, for example, description information indicating the existence of the first question data and the second answer data, so that the deep learning model can generate the third answer data on this basis.

FIG. 3 is a schematic diagram of a data generation process according to an example embodiment of the present disclosure. As shown in FIG. 3, in this example, the data generation process for interacting with a user may be implemented using an intelligent interaction system 300.

Referring to FIG. 3, the intelligent interaction system 300 includes a user feedback identification model 301, a reflection generation network 302, a deep learning model 303, and a memory bank 304.

In this example, a data transmission path including the user feedback identification model 301, the reflection generation network 302, and the memory bank 304 is optional. When the user sends first question data, and the memory bank 304 does not include historical data similar to the first question data, the deep learning model 303 may directly generate first answer data based on the first question data input by the user. After first feedback from the user for the first answer data is received, the user feedback identification model 301 may be used to determine whether the first feedback is negative feedback. When it is determined that the first feedback is negative feedback, the reflection generation network 302 may be used to obtain a first reflection result based on the first answer data and the first feedback, and then the deep learning model 303 may be used to determine new second answer data based on the first question data and the first reflection result, and the first question data and the second answer data may be stored into the memory bank 304.

When second question data is received and it is determined that the first question data similar to the second question data 304 already exists in the memory bank 304, the deep learning model 303 may be used to determine third answer data for the second question data based on the first question data, the second answer data, and the second question data, so as to use the first question data and the second answer data to enhance the generation of the current third answer data and improve the quality of answer data generated.

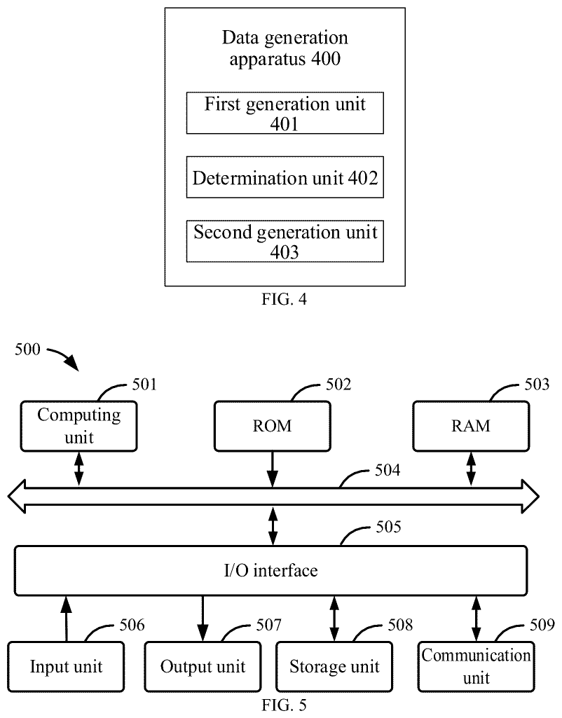

According to an aspect of the present disclosure, a data generation apparatus is further provided. FIG. 4 is a block diagram of a structure of a data generation apparatus 400 according to an example embodiment of the present disclosure. As shown in FIG. 4, the apparatus 400 includes: a first generation unit 401 configured to generate first answer data based on first question data from a user; a determination unit 402 configured to determine, in response to receiving negative feedback from the user for the first answer data, a first reflection result for the first answer data based on the first answer data and the negative feedback, the first reflection result indicating a diagnosis reason why feedback from the user for the first answer data is negative; and a second generation unit 403 configured to generate second answer data for the first question data based on the first question data and the first reflection result.

According to some embodiments, the first generation unit 401 includes: a first determination subunit configured to determine first input data for a deep learning model based on the first question data, the deep learning model being used to generate answer data based on input data; and a first input subunit configured to input the first input data into the deep learning model to obtain the first answer data, and where the second generation unit 403 includes: a second determination subunit configured to determine second input data for the deep learning model based on the first question data and the first reflection result; and a second input subunit configured to input the second input data into the deep learning model to obtain the second answer data.

According to some embodiments, the second input subunit is configured to: determine the second input data based on the first question data, the first reflection result, and task description information, the task description information indicating that the second input data includes the first reflection result.

According to some embodiments, the determination unit 402 is configured to: input the first answer data and the first feedback into a reflection generation network to obtain the first reflection result output by the reflection generation network, where the reflection generation network is trained using a sample corpus, and the sample corpus includes sample answer data, sample feedback, and a sample reflection result for the sample answer data.

According to some embodiments, the determination unit 402 is configured to: determine, in response to receiving first feedback from the user for the first answer data, and in response to determining that the first feedback is negative feedback, the first reflection result for the first answer data based on the first answer data and the first feedback.

According to some embodiments, the apparatus 400 further includes: a third generation unit configured to generate, in response to determining that a similarity between second question data from the user and the first question data exceeds a preset threshold, third answer data for the second question data based on the first question data, the second answer data, and the second question data.

According to some embodiments, the apparatus 400 further includes: a storage unit configured to store the first question data and the second answer data into a memory bank, where the third generation unit includes: an obtaining subunit configured to obtain the second answer data from the memory bank in response to determining that the similarity between the second question data from the user and the first question data in the memory bank exceeds the preset threshold; and a generation subunit configured to generate the third answer data based on the first question data, the second answer data, and the second question data.

According to some embodiments, the first reflection result further includes an optimization strategy for the first answer data.

In the technical solutions of the present disclosure, collection, storage, use, processing, transmission, provision, disclosure, etc. of user personal information involved all comply with related laws and regulations and are not against the public order and good morals.

According to another aspect of the present disclosure, an electronic device is further provided, including: at least one processor; and a memory communicatively connected to the at least one processor, where the memory stores instructions executable by the at least one processor, and the instructions, when executed by the at least one processor, cause the at least one processor to perform the foregoing data generation method.

According to another aspect of the present disclosure, a non-transitory computer-readable storage medium storing computer instructions is further provided, where the computer instructions are used to cause the computer to perform the foregoing data generation method.

According to another aspect of the present disclosure, a computer program product is further provided, including a computer program, where when the computer program is executed by a processor, the foregoing data generation method is implemented.

Referring to FIG. 5, a block diagram of a structure of an electronic device 500 that can serve as a server or a client of the present disclosure is now described, which is an example of a hardware device that may be applied to various aspects of the present disclosure. The electronic device is intended to represent various forms of digital electronic computer devices, such as a laptop computer, a desktop computer, a workstation, a personal digital assistant, a server, a blade server, a mainframe computer, and other suitable computers. The electronic device may further represent various forms of mobile apparatuses, such as a personal digital assistant, a cellular phone, a smartphone, a wearable device, and other similar computing apparatuses. The components shown in the present specification, their connections and relationships, and their functions are merely examples, and are not intended to limit the implementation of the present disclosure described and/or required herein.

As shown in FIG. 5, the device 500 includes a computing unit 501. The computing unit may perform various appropriate actions and processing according to a computer program stored in a read-only memory (ROM) 502 or a computer program loaded from a storage unit 508 to a random access memory (RAM) 503. The RAM 503 may further store various programs and data required for the operation of the device 500. The computing unit 501, the ROM 502, and the RAM 503 are connected to each other through a bus 504. An input/output (I/O) interface 505 is also connected to the bus 504.

A plurality of components in the device 500 are connected to the I/O interface 505, including: an input unit 506, an output unit 507, the storage unit 508, and a communication unit 509. The input unit 506 may be any type of device capable of entering information to the device 500. The input unit 506 may receive entered digit or character information, and generate a key signal input related to user settings and/or function control of the electronic device, and may include, but is not limited to, a mouse, a keyboard, a touchscreen, a trackpad, a trackball, a joystick, a microphone, and/or a remote controller. The output unit 507 may be any type of device capable of presenting information, and may include, but is not limited to, a display, a speaker, a video/audio output terminal, a vibrator, and/or a printer. The storage unit 508 may include, but is not limited to, a magnetic disk and an optical disc. The communication unit 509 allows the device 500 to exchange information/data with other devices via a computer network such as the Internet and/or various telecommunications networks, and may include, but is not limited to, a modem, a network interface card, an infrared communications device, a wireless communications transceiver, and/or a chipset, for example, a Bluetooth device, an 802.11 device, a Wi-Fi device, a WiMax device, or a cellular communication device.

The computing unit 501 may be various general-purpose and/or special-purpose processing components with processing and computing capabilities. Some examples of the computing unit 501 include, but are not limited to, a central processing unit (CPU), a graphics processing unit (GPU), various dedicated artificial intelligence (AI) computing chips, various computing units that run machine learning model algorithms, a digital signal processor (DSP), and any appropriate processor, controller, microcontroller, etc. The computing unit 501 performs the various methods and processing described above, for example, the data generation method. For example, in some embodiments, the data generation method may be implemented as a computer software program, which is tangibly contained in a machine-readable medium, such as the storage unit 508. In some embodiments, a part or all of the computer program may be loaded and/or installed onto the device 500 via the ROM 502 and/or the communication unit 509. When the computer program is loaded onto the RAM 503 and executed by the computing unit 501, one or more steps of the data generation method described above may be performed. Alternatively, in other embodiments, the computing unit 501 may be configured, by any other appropriate means (for example, by means of firmware), to perform the data generation method.

Various implementations of the systems and technologies described herein above can be implemented in a digital electronic circuit system, an integrated circuit system, a field programmable gate array (FPGA), an application-specific integrated circuit (ASIC), an application-specific standard product (ASSP), a system-on-chip (SOC) system, a complex programmable logical device (CPLD), computer hardware, firmware, software, and/or a combination thereof. These various implementations may include: implementation in one or more computer programs, where the one or more computer programs may be executed and/or interpreted on a programmable system including at least one programmable processor. The programmable processor may be a dedicated or general-purpose programmable processor that can receive data and instructions from a storage system, at least one input apparatus, and at least one output apparatus, and transmit data and instructions to the storage system, the at least one input apparatus, and the at least one output apparatus.

Program codes used to implement the method of the present disclosure can be written in any combination of one or more programming languages. These program codes may be provided for a processor or a controller of a general-purpose computer, a special-purpose computer, or other programmable data processing apparatuses, such that when the program codes are executed by the processor or the controller, the functions/operations specified in the flowcharts and/or block diagrams are implemented. The program codes may be completely executed on a machine, or partially executed on a machine, or may be, as an independent software package, partially executed on a machine and partially executed on a remote machine, or completely executed on a remote machine or a server.

In the context of the present disclosure, the machine-readable medium may be a tangible medium, which may contain or store a program for use by an instruction execution system, apparatus, or device, or for use in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In order to provide interaction with a user, the systems and technologies described herein can be implemented on a computer which has: a display apparatus (for example, a cathode-ray tube (CRT) or a liquid crystal display (LCD) monitor) configured to display information to the user; and a keyboard and a pointing apparatus (for example, a mouse or a trackball) through which the user can provide an input to the computer. Other categories of apparatuses can also be used to provide interaction with the user; for example, feedback provided to the user can be any form of sensory feedback (for example, visual feedback, auditory feedback, or tactile feedback), and an input from the user can be received in any form (including an acoustic input, a voice input, or a tactile input).

The systems and technologies described herein can be implemented in a computing system (for example, as a data server) including a backend component, or a computing system (for example, an application server) including a middleware component, or a computing system (for example, a user computer with a graphical user interface or a web browser through which the user can interact with the implementation of the systems and technologies described herein) including a frontend component, or a computing system including any combination of the backend component, the middleware component, or the frontend component. The components of the system can be connected to each other through digital data communication (for example, a communication network) in any form or medium. Examples of the communication network include: a local area network (LAN), a wide area network (WAN), the Internet, and a blockchain network.

A computer system may include a client and a server. The client and the server are generally far away from each other and usually interact through a communication network. A relationship between the client and the server is generated by computer programs running on respective computers and having a client-server relationship with each other. The server may be a cloud server, a server in a distributed system, or a server combined with a blockchain.

It should be understood that steps may be reordered, added, or deleted based on the various forms of procedures shown above. For example, the steps recorded in the present disclosure may be performed in parallel, in order, or in a different order, provided that the desired result of the technical solutions disclosed in the present disclosure can be achieved, which is not limited herein.

Although the embodiments or examples of the present disclosure have been described with reference to the accompanying drawings, it should be understood that the methods, systems, and devices described above are merely example embodiments or examples, and the scope of the present invention is not limited by the embodiments or examples. Various elements in the embodiments or examples may be omitted or substituted by equivalent elements thereof. Moreover, the steps may be performed in an order different from that described in the present disclosure. Further, various elements in the embodiments or examples may be combined in various ways. It is important that, as the technology evolves, many elements described herein may be replaced with equivalent elements that appear after the present disclosure.

1. A data generation method, the method comprising:
generating first answer data based on first question data from a user;
determining, in response to receiving negative feedback from the user for the first answer data, a first reflection result for the first answer data based on the first answer data and the negative feedback, wherein the first reflection result indicates a diagnosis reason why feedback from the user for the first answer data is negative; and
generating second answer data for the first question data based on the first question data and the first reflection result.

2. The method according to claim 1, wherein generating first answer data based on first question data from a user comprises:
determining first input data for a deep learning model based on the first question data, wherein the deep learning model is used to generate answer data based on input data; and
inputting the first input data into the deep learning model to obtain the first answer data,
and wherein generating second answer data for the first question data based on the first question data and the first reflection result comprises:
determining second input data for the deep learning model based on the first question data and the first reflection result; and
inputting the second input data into the deep learning model to obtain the second answer data.

3. The method according to claim 2, wherein determining second input data for the deep learning model based on the first question data and the first reflection result comprises:
determining the second input data based on the first question data, the first reflection result, and task description information, which indicates that the second input data includes the first reflection result.

4. The method according to claim 1, wherein determining a first reflection result for the first answer data based on the first answer data and the negative feedback comprises
inputting the first answer data and the negative feedback into a reflection generation network to obtain the first reflection result output by the reflection generation network, wherein the reflection generation network is trained using a sample corpus, which includes sample answer data, sample feedback, and a sample reflection result for the sample answer data.

5. The method according to claim 1, wherein determining, in response to receiving negative feedback from the user for the first answer data, a first reflection result for the first answer data based on the first answer data and the negative feedback comprises:
determining, in response to receiving first feedback from the user for the first answer data, and in response to determining that the first feedback is negative, the first reflection result for the first answer data based on the first answer data and the first feedback.

6. The method according to claim 1, further comprising:
generating, in response to determining that a similarity between second question data from the user and the first question data exceeds a preset threshold, third answer data for the second question data based on the first question data, the second answer data, and the second question data.

7. The method according to claim 6, further comprising:
storing the first question data and the second answer data into a memory bank,
wherein generating, in response to determining that a similarity between second question data from the user and the first question data exceeds the preset threshold, third answer data for the second question data based on the first question data, the second answer data, and the second question data comprises:
obtaining the second answer data from the memory bank in response to determining that the similarity between the second question data from the user and the first question data in the memory bank exceeds the preset threshold; and
generating the third answer data based on the first question data, the second answer data, and the second question data.

8. The method according to claim 1, wherein the first reflection result further comprises an optimization strategy for the first answer data.

9. An electronic device, comprising:
at least one processor; and
a memory communicatively connected to the at least one processor, wherein
the memory stores instructions executable by the at least one processor, and the instructions, when executed by the at least one processor, cause the at least one processor to perform operations comprising:
generating first answer data based on first question data from a user;
determining, in response to receiving negative feedback from the user for the first answer data, a first reflection result for the first answer data based on the first answer data and the negative feedback, wherein the first reflection result indicates a diagnosis reason why feedback from the user for the first answer data is negative; and
generating second answer data for the first question data based on the first question data and the first reflection result.

10. The electronic device according to claim 9, wherein generating first answer data based on first question data from a user comprises:
determining first input data for a deep learning model based on the first question data, wherein the deep learning model is used to generate answer data based on input data; and
inputting the first input data into the deep learning model to obtain the first answer data,
and wherein generating second answer data for the first question data based on the first question data and the first reflection result comprises:
determining second input data for the deep learning model based on the first question data and the first reflection result; and
inputting the second input data into the deep learning model to obtain the second answer data.

11. The electronic device according to claim 10, wherein determining second input data for the deep learning model based on the first question data and the first reflection result comprises:
determining the second input data based on the first question data, the first reflection result, and task description information, which indicates that the second input data includes the first reflection result.

12. The electronic device according to claim 9, wherein determining a first reflection result for the first answer data based on the first answer data and the negative feedback comprises:
inputting the first answer data and the negative feedback into a reflection generation network to obtain the first reflection result output by the reflection generation network, wherein the reflection generation network is trained using a sample corpus, which includes sample answer data, sample feedback, and a sample reflection result for the sample answer data.

13. The method according to claim 9, wherein determining, in response to receiving negative feedback from the user for the first answer data, a first reflection result for the first answer data based on the first answer data and the negative feedback comprises:
determining, in response to receiving first feedback from the user for the first answer data, and in response to determining that the first feedback is negative, the first reflection result for the first answer data based on the first answer data and the first feedback.

14. The electronic device according to claim 9, wherein the instructions, when executed by the at least one processor, further cause the at least one processor to perform operations comprising:
generating, in response to determining that a similarity between second question data from the user and the first question data exceeds a preset threshold, third answer data for the second question data based on the first question data, the second answer data, and the second question data.

15. The electronic device according to claim 14, wherein the instructions, when executed by the at least one processor, further cause the at least one processor to perform operations comprising:
storing the first question data and the second answer data into a memory bank,
wherein generating, in response to determining that a similarity between second question data from the user and the first question data exceeds the preset threshold, third answer data for the second question data based on the first question data, the second answer data, and the second question data comprises:
obtaining the second answer data from the memory bank in response to determining that the similarity between the second question data from the user and the first question data in the memory bank exceeds the preset threshold; and
generating the third answer data based on the first question data, the second answer data, and the second question data.

16. The electronic device according to claim 9, wherein the first reflection result further comprises an optimization strategy for the first answer data.

17. A non-transitory computer-readable storage medium storing computer instructions, wherein the computer instructions are used to cause a computer to perform operations comprising:
generating first answer data based on first question data from a user;
determining, in response to receiving negative feedback from the user for the first answer data, a first reflection result for the first answer data based on the first answer data and the negative feedback, wherein the first reflection result indicates a diagnosis reason why feedback from the user for the first answer data is negative; and
generating second answer data for the first question data based on the first question data and the first reflection result.

18. The non-transitory computer-readable storage medium according to claim 17, wherein generating first answer data based on first question data from a user comprises:
determining first input data for a deep learning model based on the first question data, wherein the deep learning model is used to generate answer data based on input data; and
inputting the first input data into the deep learning model to obtain the first answer data,
and wherein generating second answer data for the first question data based on the first question data and the first reflection result comprises:
determining second input data for the deep learning model based on the first question data and the first reflection result; and
inputting the second input data into the deep learning model to obtain the second answer data.

19. The non-transitory computer-readable storage medium according to claim 18, wherein determining second input data for the deep learning model based on the first question data and the first reflection result comprises:
determining the second input data based on the first question data, the first reflection result, and task description information, which indicates that the second input data includes the first reflection result.

20. The non-transitory computer-readable storage medium according to claim 17, wherein determining a first reflection result for the first answer data based on the first answer data and the negative feedback comprises:
inputting the first answer data and the negative feedback into a reflection generation network to obtain the first reflection result output by the reflection generation network, wherein the reflection generation network is trained using a sample corpus, which includes sample answer data, sample feedback, and a sample reflection result for the sample answer data.
